(19) United States
(12) Patent Application Publication
(10) Pub. No.: US 2011/0182959 A1
(43) Pub. Date: Jul. 28, 2011

(54) REMOVABLE ANTIMICROBIAL COATING COMPOSITIONS CONTAINING ACID-ACTIVATED RHEOLOGY AGENT AND METHODS OF USE

(75) Inventors: William R. Cahill, Hockessin, DE (US); Carl W. Erkenbrecher, JR., Elkton, MD (US); Christian Hoffmann, Newark, DE (US); Shaun F. Malone, Ajax (CA)

(73) Assignee: E.I. DU PONT DE NEMOURS AND COMPANY., Wilmington, DE (US)

(21) Appl. No.: 12/843,096

(22) Filed: Jul. 26, 2010

Related U.S. Application Data
(60) Provisional application No. 61/288,800, filed on Dec. 21, 2009.
(60) Provisional application No. 61/288,807, filed on Dec. 21, 2009.
(60) Provisional application No. 61/288,811, filed on Dec. 21, 2009.
(60) Provisional application No. 61/228,800, filed on Jul. 27, 2009.
(60) Provisional application No. 61/228,807, filed on Jul. 27, 2009.
(60) Provisional application No. 61/228,811, filed on Jul. 27, 2009.

(51) Int. Cl. A01N 33/12; A01N 25/34; A01P 1/00

(52) U.S. Cl. 424/405; 514/643

(57) ABSTRACT

A method is provided for controlling microorganisms comprising coating a surface with a removable, antimicrobial film-forming composition. More specifically, the removable, antimicrobial film-forming composition comprises at least one antimicrobial agent and at least one acid-activated rheology agent.

This application claims the benefit of the three U.S. Provisional Applications 61/228,800, 61/228,807, and 61/228,811 all filed on Jul. 27, 2009.

### FIELD OF THE INVENTION

This invention relates to a method for controlling microorganisms comprising coating a surface with a removable, antimicrobial film-forming composition that comprises one or more acid-activated rheology agents and methods of applying said composition.

### BACKGROUND

Microbial infection represents a serious continuing problem in human and animal health. Exposure to microbial pathogens can occur in a variety of settings, such as public facilities and hospitals, and also includes contamination of consumer products and food processing plants. The attachment of microorganisms to a surface can generate a biofilm that can be less susceptible to disinfectants.

U.S. Pat. No. 5,585,407 describes water-based removable coating compositions comprising an acrylate emulsion polymer and an organoalkoxysilane.

U.S. Patent Application Publication 2005/0175568 describes a conditioning composition comprising hydrophobically modified crosslinked cationic thickening polymers.

U.S. Pat. No. 6,025,431 describes thickened personal care compositions comprising an acrylate-based polymeric rheology modifier and a cosmetically active agent.

U.S. Patent Application No. 2008/0138312 describes a method comprising a biostatic polymer composition comprising poly(vinyl alcohol), a quaternary ammonium compound and a surfactant.

U.S. Pat. No. 5,017,369 describes a film-forming dairy cow teat sealer for prevention of mastitis comprising polyvinyl alcohol, an antimicrobial agent and water.

U.S. Pat. No. 6,749,869 describes a mastitis control teat dip composition providing rapid initial kill, pseudoplastic rheology, a barrier/film-forming capacity, and long term microbial control.

Problems in achieving effective and long lasting control of microbial growth are: insufficient contact time between surface and disinfectant, inefficient surface coverage, and lack of residual efficacy to protect the surface against fresh contamination. Conventional antimicrobial coating compositions can have poor rheological properties.

Further, conventional removable antimicrobial coating compositions may not provide one or more of the following desirable characteristics: (i) antimicrobial properties against a broad range of microorganisms, including self-sanitizing activity; (ii) shelf-stability of the liquid coating composition; (iii) fast application to large surface areas to be protected; (iv) efficiency, including providing a thin coating and a high transfer efficiency to the target surface, (v) acceptable appearance of the coated surface, (vi) complete and easy removal of the coating, and (vii) a simple and fast manufacturing process of the coating composition. These problems can be related to inattention or inability to control the rheology of an antiseptic composition.

Rheology modifiers are known and typically used to modify the rheological properties of aqueous compositions. Such properties include: viscosity, flow rate, stability to viscosity change over time, and the ability to suspend particles in such aqueous compositions. Examples of conventional rheology modifiers include thickeners such as cellulosic derivatives, polyvinyl alcohol, sodium polyacrylate, and other water-soluble macromolecules, and copolymeric emulsions in which monomers with acid groups have been introduced onto the main chain. Thickeners such as cellulosic derivatives and polyvinyl alcohol can exhibit poor stability to viscosity change over time. Rheology modifiers known as associative modifiers are described in U.S. Pat. Nos. 4,743,698; 4,600,761; RE 33,156; 4,792,343; 4,384,096; 3,657,175; 5,102,936 and 5,294,692. These thickeners become effective upon the addition of base, but are not effective in acidic media.

Alkaline conditions are not desirable for formulations that contain alkali-hydrolyzable functional groups, such as the acetate-functional groups present in partially hydrolyzed poly(vinyl alcohol). Hydrolysis can result in unstable formulations characterized by a changing pH, viscosity, or phase separation of the composition, in addition to other physical and/or chemical property changes over time.

It can be desirable to have a removable antimicrobial coating composition having rheological characteristics that provide durable coatings.

### SUMMARY OF THE INVENTION

The present invention addresses the problems identified above by providing a composition that is antimicrobial and a method which provides extended effectiveness against microorganisms by forming an antimicrobial coating on a target surface, wherein the coating comprises at least one antimicrobial agent and at least one acid-activated rheology agent.

The present invention is a method of providing control of microorganisms at a locus comprising the steps:
a) combining:
   i) a water soluble or water-dispersible film-forming agent;
   ii) at least one cationic or nonionic antimicrobial agent;
   iii) an inert solvent;
   iv) an acid activated rheology agent;
   v) an acid in an amount effective to initiate thickening by the rheology agent of (iv) to obtain a removable coating composition; and
b) applying said coating composition to said locus.

The present invention also provides for a removable antimicrobial coating composition for application at a locus, said composition obtained by combining:
i) a water soluble or water-dispersible film-forming agent;
ii) at least one cationic or nonionic antimicrobial agent;
iii) an inert solvent;
iv) an acid activated rheology agent; and
v) an acid in an amount effective to initiate thickening by the rheology agent of (iv).

The present invention also provides for an article comprising on at least one surface thereof a removable antimicrobial coating composition, wherein the composition comprises the reaction products obtained by combining:

i) a water soluble or water-dispersible film-forming agent;

ii) at least one antimicrobial agent;

iii) an inert solvent;

iv) an acid-activated rheology agent;

v) an acid in an amount effective to initiate thickening by the rheology agent of (iv).

### DETAILED DESCRIPTION

Unless stated otherwise, all percentages, parts, ratios, etc., are by weight. Further, when an amount, concentration, or other value is disclosed as either a range, preferred range or a list of preferred upper and lower values, such disclosure is to have the same effect as if each individual value within the specified range—and any range obtained from a combination of any two individual values within the disclosed range—has been specifically disclosed, even if the individual values are not uniquely or individually disclosed herein. Where a range of numerical values is recited herein, unless otherwise stated, the range is intended to include the endpoints thereof, and all integers and fractions within the range. Unless specified, it is not intended that the scope of the invention be limited to the specific values recited when defining a range.

For clarity, terms used herein are to be understood as described herein or as such term would be understood by one of ordinary skill in the art of the invention. Additional explanation of certain terms used herein, are provided below.

“Removable coating composition” or “coating composition” refers to a film-forming composition comprising a water soluble or water-dispersible film-forming agent, at least one antimicrobial agent, an inert solvent, an acid activated rheology agent and an acid in an amount effective to activate the rheology agent.

“Shear rate” refers to the velocity gradient in a flowing material and is measured in SI units of reciprocal seconds (s⁻¹).

“Shear-thinning properties” or “pseudoplastic properties” refers to a fluid that exhibits a decrease in viscosity with an increase in shear rate.

“Non-volatile” refers to a compound whose vapor pressure at 25° C. is below 1000 Pascals.

“Rheology modifier” or “rheology agent” refers to compounds that increase viscosity and/or provide shear-thinning properties to a composition and cause the aqueous treatment or coating composition to cling to the surface of interest.

“wt %” refers to the weight percent relative to the total weight of the solution or dispersion.

“Microorganism” is meant to include any microorganism comprised of the phylogenetic domains of bacteria and archaea, as well as unicellular (e.g., yeasts) and filamentous (e.g., molds) fungi, unicellular and filamentous algae, unicellular and multicellular parasites, viruses, virinos and viroids.

“Film-forming agent” or “water soluble or water dispersible coating agent”, which may be used interchangeably herein, refers to agents that form a film and are employed to provide protective coating to the surface of interest. These agents are either water soluble (that is, form aqueous solutions) or water dispersible (that is, form aqueous dispersions). These agents are described in further detail below.

“Inert solvent or aqueous solvent” refers to water or any other solvent that facilitates application of the water dispersible coating agent and surfactant to the locus. An aqueous solvent may also be employed to rinse coated surfaces to remove the coating as needed.

“Liquid coating composition” refers to the claimed composition comprising an amount of a water soluble or water-dispersible film-forming agent, an antimicrobial agent, an inert solvent, an acid activated rheology agent and an acid in an amount effective to activate the rheology agent.

“Antimicrobial agent” as used herein refers to a compound or substance having antimicrobial properties

“Biocide”, as used herein, refers to a chemical agent, typically broad spectrum, which inactivates or destroys microorganisms. A chemical agent that exhibits the ability to inactivate or destroy microorganisms is described as having “biocidal” activity.

“Biofilm” refers to a structured community of microorganisms encapsulated within a self-developed polymeric matrix and adherent to a living or inert surface.

“Drying” refers to a process by which the inert solvent or any other liquid present in the formulation is removed by evaporation.

“Disinfectant” as used herein is a chemical that kills 99.9% of the specific test microorganisms in 10 minutes under the conditions of the test. (Germicidal and Detergent Sanitizing Action of Disinfectants, Official Methods of Analysis of the Association of Official Analytical Chemists, paragraph 960.09 and applicable sections, 15th Edition, 1990; EPA Guideline 91-2).

“Locus” as used herein, comprises part or all of a target surface suitable to be coated.

“Antimicrobial” or “antimicrobial properties” refer to the ability of an agent of killing microorganisms, blocking or preventing microbial contamination (such as a forming a barrier), or suppressing or preventing growth of microorganisms, trapping microorganisms for killing, or preventing biofilm formation.

“Dry” or “essentially dry” refers to a coating composition that has lost at least 70%, more preferably 80%, even more preferably 90%, most preferably more than 95% of the inert solvent as defined herein due to evaporation.

“Sag point” refers to the thickness at which a dried coating begins to show visual sags or drips after application to a vertical surface.

“Homogeneous” or “substantially homogenous”, as used herein refers to a coating with only negligible thickness variations across the coating surface.

“Continuous”, or “substantially continuous”, as used herein refers to a coating that covers the target surface without uncovered areas, coating defects, such as craters and holes or breaks.

“Quaternary ammonium compound” refers to a salt of an anion and a quaternary ammonium cation of the structure

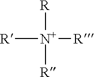

with R, R′, R″ and R′″ being either alkyl or aryl groups or any combination of the two.

“Alpha-hydroxy acid” refers to a carboxylic acid containing a hydroxy group on the carbon adjacent to the carboxyl group.

For clarity, terms used herein are to be understood as described herein or as such term would be understood by one of ordinary skill in the art of the invention. Additional explanation of certain terms used herein, are provided below:

Antimicrobial coatings of the present invention are durable. “Durable” as the term is used herein refers to the ability of a dried coating to remain on the surface until its removal is purposely initiated or allowed to occur. Use conditions are the environmental conditions prevalent during the period the coating remains on the target surface for the application areas of this disclosure and can include inadvertent contact with water of a temperature below about 40° C.

Antimicrobial coatings of the present invention provide a physical barrier to contamination. “Physical barrier” as used herein refers to the barrier formed after application of the present film-forming coating composition that protects a treated surface from contamination from, for example, soil, fat, dust, microorganisms, etc after the film has dried.

“Contact time” refers to the time the coating or coating composition provides antimicrobial properties to microorganisms that come into contact or the vicinity of said coating or coating composition. Depending on the specific requirements for the antimicrobial formulations, the contact time would vary, as set out in “Germicidal and Detergent Sanitizing Action of Disinfectants, Official Methods of Analysis of the Association of Official Analytical Chemists”, paragraph 960.09 and applicable sections, 15th Edition, 1990; EPA Guideline 91-2. For example, if the intended application of the present disclosure is use as a sanitizer for food-contact surfaces, then the composition should provide a 99.999% reduction (5-log order reduction) within 30 seconds at room temperature against several test microorganisms. If the intended application is as a sanitizer for non-food contact surfaces, then the composition should provide a 99.9% reduction (3-log order reduction) within 5 minutes at room temperature against several test microorganisms. If the intention is to use the disclosure as a disinfectant, then the composition should provide a 99.9% reduction (3-log order reduction) within 10 minutes. If the intended application is to provide residual antimicrobial activity, then the present method would be allowed to have greater than 10 minute contact time with microorganisms.

Antimicrobial coating compositions of the present invention can be contained in multi-compartment systems. “Multi-compartment system” refers to the means of keeping the two or more reactive components of a multicomponent system separated before use. In one aspect, a multi-compartment system comprises at least two compartments and may contain a multi-chamber dispenser bottle or a two-phase system used to combine reactive compounds in liquid form. In another aspect, any kind of system, device, container, package, bag, kit, multi-pack, dispenser, or applicator that is used to keep reactive components separated before use can be used according to the methods of this disclosure.

An antimicrobial coating composition of the present invention is generated by mixing a first liquid with a second liquid, wherein the first liquid comprises an acid-activated rheology agent and the second liquid comprises an acid in an amount sufficient to lower the pH of the resulting mixture to pH 8.5 or below.

As such, the components of the coating composition may be provided as a multicomponent system wherein one or more of the components remain separated until use. A suitable system for storing reactive components separately and subsequently combining them at the time of use is disclosed in U.S. Patent Application Pub. No. 2005/014427. An alternative device suitable for use in the practice of the present invention is a dual compartment trigger-activated fluid dispenser as disclosed in EP Patent No. 071589981.

It can be desirable that a coating composition of the present invention have a pseudoplastic index or shear thinning index (STI) indicative of a composition that resists sagging and dripping. The shear thinning index as used herein is defined as the ratio of the viscosity measured at a first shear rate and a second shear rate, wherein said second shear rate is 10 times the value of said first shear rate. Without being limited to specific first and second shear rates used to calculate the STI, in the Examples said first shear rate was 1 s⁻¹ and said second shear rate was 10 s⁻¹.

A composition of the present invention can be used as a sanitizer or as a disinfectant. Sanitizer, as defined herein, is a chemical or chemical mixture that can be either (i) a food-contact sanitizer if the intention is to control microorganisms on surfaces that can come into contact with food, or (ii) a non-food-contact sanitizer if the surfaces are not intended to come into contact with food. As defined herein, a food-contact sanitizer kills at least 99.999% of the specific test microorganisms in 30 seconds under the conditions of the test method according to EPA policy DIS/TSS-4: “Efficacy data requirements—Sanitizing rises for previously cleaned food-contact surfaces”, United States Environmental Protection Agency, Jan. 30, 1979. A non-food contact sanitizer as defined herein kills at least 99.9% of the specific test microorganisms in 5 minutes under the conditions of the method according to ASTM standard E 1153-03: “Standard Test Method for Efficacy of Sanitizers Recommended for Inanimate Non-Food Contact Surfaces”, edition Apr. 10, 2003 and published July 2003.

A disinfectant, as defined herein, is a chemical that kills 99.9% of the specific test microorganisms in 10 minutes under the conditions of the test. (Germicidal and Detergent Sanitizing Action of Disinfectants, Official Methods of Analysis of the Association of Official Analytical Chemists, paragraph 960.09 and applicable sections, 15th Edition, 1990; EPA Guideline 91-2).

Antimicrobial compositions useful herein have residual antimicrobial efficacy. The term ‘residual antimicrobial efficacy’ (or self-sanitizing properties) describes the property of coating compositions according to this method, wherein the coatings remain antimicrobial after drying. According to this invention, at least a 99.9% reduction of colony-forming units is achieved using the residual self-sanitizing (RSS) test methods described below.

There has been a longstanding need for antimicrobial agents having improved antimicrobial efficacy and improved speed of action. The specific requirements for such agents vary according to the intended application (e.g., sanitizer, disinfectant, sterilant, aseptic packaging treatment, etc.) and the applicable public health requirements. For example, as set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2), a sanitizer should provide a 99.999% reduction (5-log order reduction) within 30 seconds at room temperature (23-27° C.), against several test organisms.

The removable antimicrobial coating composition of the present method may be used as a replacement for standard sanitation products (such as diluted quaternary ammonium compound solutions or foams, peracid solutions or foams, and the like), and may be used for daily sanitation as protective coatings for equipment in use or not-in use, as well as for longer term protection, that is, protection over weeks or months).

The removable antimicrobial coating composition useful in the practice of the present invention provides several advantages including, but not limited to killing both loose or planktonic microorganisms and microorganisms harbored in biofilms, reducing or preventing the growth of microorganisms by preventing the formation of biofilms and by trapping microorganisms in, beneath or otherwise in contact with the coating.

The coating composition disclosed herein may be modified by formulating the composition with rheology modifiers to coat vertical, inclined, geometrically complex or hard-to-reach surfaces. This enables application of the antimicrobial agent to surfaces on or in equipment otherwise not accessible by application of conventional antimicrobial solutions with traditional shear-viscosity profiles and viscosities below about 0.01 Pascal-seconds at 25° C. Horizontal and vertical surfaces may be covered with a thin layer of protective coating without waste of antimicrobial agent as dripping is prevented or greatly reduced by the rheology modifier. By formulating compositions with appropriate rheology modifier and degree of cross-linking, coating compositions with various coating properties may be prepared that will vary in the degree of surface finish and protection as well as ease of removal.

The coating composition of the present invention offers several mechanisms of protection towards contamination of microbial or non-microbial origin, such as soiling. For example, as the liquid composition is applied, planktonic or loosely adhering cells on the surface are killed, or growth is reduced or prevented by the antimicrobial agent in the coating formulation.

Further, after application of the antimicrobial composition of the present invention, cells harbored by biofilms on the surface will be killed, or growth can be reduced or prevented, by diffusion of the antimicrobial(s) into the hydrated biofilm before the applied film-forming composition completely dries to provide an antimicrobial film. For sustained antimicrobial activity it is desirable that the antimicrobial films of the present invention be semi permeable. The antimicrobial film thus formed constitutes a reservoir of antimicrobial agent providing much longer contact time than conventional sanitary rinse solutions that typically drip off within seconds or minutes.

The long lasting activity while the coating is present on the locus is especially beneficial in a variety of applications. A film-forming antimicrobial composition of the present method does not drip off of the target surface quickly, and is durable. The variation of film flexibility, viscosity, strength, and adhesion of the coating of the present invention permits it to be tailored to specific applications, and thus provide a residual benefit to applications not previously.

In one embodiment of the present method, the antimicrobial, removable coating composition useful in the practice of the present invention is applied to equipment in the food, dairy, or beverage industries during shutdown periods of the equipment, for example. When the equipment is started up, the coating is removed by a method described herein. In another embodiment, the antimicrobial, removable coating composition is used for sanitation of surfaces, such as surfaces of equipment of the food or beverage industry, for daily or weekly sanitation purposes. In yet another embodiment, fruit surfaces can be coated with the removable coating composition to prevent microbial spread and cross-contamination in food processing facilities. In still another embodiment, hospital walls, beds, and other hospital surfaces can be coated with the antimicrobial, removable coating composition useful for the present method. In another embodiment drains are coated with the removable coating composition. In another embodiment, building surfaces, such as in new home construction, walls or other surfaces are coated for prevention of mold contamination or mold removal.

The coating composition offers several mechanisms of protection towards contamination of microbial or non-microbial origin, such as soiling. First, as the fluid composition is applied, planktonic or loosely adhering cells on the surface are killed, or growth is reduced or prevented, by the antimicrobial agent in the coating formulation. Second, cells harbored by biofilms on the surface will be killed (or growth will be reduced or prevented) by diffusion of the antimicrobial(s) from the fluid coating into the hydrated biofilm. The antimicrobial film thus formed constitutes a reservoir of antimicrobial agent providing much longer contact time than conventional sanitary rinse solutions typically drip off within seconds or minutes.

Third, planktonic cells reaching the antimicrobial coating from outside—after application of the antimicrobial coating—will be killed, or growth will be reduced or prevented by the antimicrobial agent. Again, the antimicrobial coating will act as a reservoir of antimicrobial agent maintaining its microbiocidal properties until it is exhausted from the coating. This mechanism will also prevent biofilms from growing on the antimicrobial coating until the antimicrobial agent has been exhausted from the coating. Typical biofilm microorganisms are Gram positive and/or Gram negative bacteria, acting as pathogens, indicator microorganisms, and/or spoilage microorganisms. Fourth, the coating constitutes a physical barrier for microorganisms, soil, fat and other matter. These solid contaminants will remain on the surface of the coating and will wash off at the time of removal of the coating. A fifth protection mechanism occurs in situations in which the coating traps microorganisms so that they cannot reach or permeate a target surface and contaminate it. The protection mechanisms can operate individually, or simultaneously, in any combination, depending on environmental conditions.

The long lasting activity while the coating is present on the locus is especially beneficial in a variety of applications. This residual benefit is far superior to antimicrobial agents such as a rinse solution that drips off quickly, or an agent that is subject to removal by touching or minor abrasion of the surface after application. The variation of film flexibility, viscosity, strength, and adhesion of the coating of the present method permits it to be tailored to specific applications, thus making sustained antimicrobial protection available in numerous situations where such sustained activity (residual benefit) was not previously available.

Suitable film-forming water soluble or water dispersible agents useful in the practice of the present invention are summarized in the commonly owned and co-pending U.S. patent applications Nos. 2008/0026026 and 2007/0275101, which are hereby incorporated by reference as if fully set out herein. Suitable film-forming agents are selected from, but are not limited to, polyvinyl alcohols, polyvinyl alcohol copolymers, polyvinyl pyrrolidones, polyacrylic acid, acrylate copolymers, ionic hydrocarbon polymers, polyurethanes, polysaccharides, functionalized polysaccharides, arabinoxylanes, glucomannanes, guar gum, gum arabic, johannistree gums, cellulose, methyl cellulose, ethyl cellulose, hydroxymethyl cellulose, hydroxyethyl cellulose, carboxymethyl cellulose, carboxyethyl cellulose starch, hydroxyethyl starch, xanthan gum, carrageenan, curdlan, pullulan, gelatin, dextran, chitosan, glycerol, sodium alginate, sodium alginate cross-linked with calcium salt, carrageenan, ethyleneoxide/propylene oxide/ethyleneoxide block copolymers, and combinations there of. One skilled in the art may easily select the range of suitable molecular weights in order to provide a range of water solubility to provide a readily removable coating according to the methods of this invention.

Rheology modifiers which are “active” in both acidic and lower range alkaline media can be prepared via free-radical emulsion polymerization utilizing colloidal stabilizers, as described in U.S. Pat. No. 5,990,233 hereby incorporated by reference. Such rheology modifiers which are suitable for use in the practice of the present invention are commercially available. An example suitable acid activated rheology agents is Alcogum® L-520 from Alco Chemical® (Chattanooga, Tenn., USA), which is a cationic compatible, acid swellable rheology modifier supplied at 20 wt % active solids in water. Alcogum® L-520 was designed to perform below pH 6 and when neutralized with an inorganic or organic acid provides a clear viscous solution.

The commercially obtained emulsions can be mixed with the antimicrobial composition described herein, but can require addition of sufficient acid to lower the pH of the antimicrobial coating composition with rheology modifier to within a pH range at which thickening occurs, e.g., a pH range of from about 0.5 to about 8.5. For the purposes of the present invention, addition of acid to lower the pH of an antimicrobial composition to effect thickening of the antimicrobial composition by a rheology modifier is said to be “acid activation”, and the rheology modifier is said to be “acid-activated”, regardless of the actual pH of the mixture after the addition of an effective amount of acid. An “effective amount of acid” is that amount of acid required to effect thickening by the rheology modifier.

The rheology agent or rheology modifier used in this disclosure provides pseudoplastic or shear-thinning properties for the coating composition. Pseudoplastic compositions are known to cling to inclined or vertical surfaces. Clinging also enables the composition to remain in contact with transient and resident microorganisms for longer periods of time, promoting microbiological efficacy and resisting waste due to excessive dripping. Clinging also enables an improved appearance of the coating as sagging and/or dripping is prevented.

Acid activated rheology agents have several advantages over non-activated or alkali-activated rheology agents. Acid swellable emulsion thickeners and hydrophobically modified acid swellable emulsion thickeners provide the desired shear-thinning properties at pH-values below 8.5. Under these conditions they are compatible with cationic agents such as quaternary ammonium compounds used as antimicrobial agents. Under these conditions, unlike alkali activated rheology agents, they are also compatible with ingredients containing ester functional groups which can hydrolyze under basic conditions such as when using partially hydrolyzed polyvinylalcohol as an ingredient in the coating composition.

Suitable acids useful in the practice of the present invention include conventionally known inorganic and organic acids capable of lowering the pH of an aqueous antimicrobial composition to pH 8.5 or below. Suitable organic acids include but are not limited to, for example: acetic acid, lactic acid, glycolic acid, citric acid, sulfamic acid, formic acid, gluconic acid, oxalic acid, tartaric acid, sulfonic acids, and mixtures thereof. Carboxylic acid derivatives such as carboxylic anhydrides and carboxylic acid halides can be suitable for use herein as acid precursors that can be converted to carboxylic acids in aqueous media under the conditions of use described herein. Suitable inorganic acids include but are not limited to, for example, sulfuric acid, phosphoric acid, hydrochloric acid, nitric acid, and mixtures thereof. Mixtures of organic and inorganic acids are suitable for use herein.

Suitable antimicrobial agents useful for the disclosure are summarized the commonly owned and co-pending U.S. patent applications Nos. 2008/0026026 and 2007/0275101.

For example, the antimicrobial agent useful for the invention can be either an inorganic or organic agent, or a mixture thereof. The invention is not to be limited to the selection of any particular antimicrobial agent, and any known water-soluble or water-dispersible antimicrobial may be included in the compositions of the invention such as antimicrobials, mildewcides, antiseptics, disinfectants, sanitizers, germicides, algicides, antifouling agents, preservatives, and combinations of the foregoing and the like provided that the antimicrobial agent is chemically compatible with other components in the composition. Suitable classes of antimicrobial agents are described below.

The term “inorganic antimicrobial agent” used herein is a general term for inorganic compounds which contain a metal or metal ions, such as silver, zinc, copper and the like which have antimicrobial properties. The term “organic antimicrobial agent” used herein is the general term for natural extracts, low molecular weight organic compounds and high molecular weight compounds all of which have antimicrobial properties and which generally contain nitrogen, sulfur, phosphorus or like elements. Examples of useful natural antimicrobial agents are chitin, chitosan, antimicrobial peptides such as nisin, lysozymes, wasabi extracts, mustard extracts, hinokitiol, tea extracts and the like. High molecular weight compounds having anti-microbial properties include those having an ammonium salt group, phosphonium salt group, sulfonium salt group or like onium salts, a phenylamide group, or a diguanide group attached to a straight or branched polymer chain, for example phosphonium salt-containing vinyl polymers, as are known in the art (E.-R. Kenawy and Y. A.-G. Mahmoud “Biologically active polymers, 6: Synthesis and antimicrobial activity of some linear copolymers with quaternary ammonium and phosphonium groups” in Macromolecular Bioscience (2003), 3(2), 107-116).

Examples of useful low molecular weight antimicrobial agents include chlorhexidine, chlorhexidine gluconate, glutaral, halazone, hexachlorophene, nitrofurazone, nitromersol, thimerosol, C1-C5-parabens, hypochlorite salts, clofucarban, clorophen, phenolics, mafenide acetate, aminacrine hydrochloride, quaternary ammonium salts, chlorine and bromine release compounds (e.g., alkali and alkaline earth hypochlorites and hypobromites, isocyanurates, chlorinated derivatives of hydantoin, sulfamide, amine, etc.), peroxide and peroxyacid compounds (e.g., peracetic acid, peroctanoic acid), protonated short chain carboxylic acids, oxychlorosene, metabromsalan, merbromin, dibromsalan, glyceryl laurate, sodium and/or zinc pyrithione, trisodium phosphates, (dodecyl)(diethylenediamine)glycine and/or (dodecyl)(aminopropyl)glycine and the like. Useful quaternary ammonium salts include the N—C10-C24-alkyl-N-benzyl-quaternary ammonium salts which comprise water solubilizing anions such as halide, e.g., chloride, bromide and iodide; sulfate, methosulfate and the like and the heterocyclic imides such as the imidazolinium salts. Useful phenolic germicides include phenol, m-cresol, o-cresol, p-cresol, o-phenyl-phenol, 4-chloro-m-cresol, chloroxylenol, 6-n-amyl-m-cresol, resorcinol, resorcinol monoacetate, p-tert-butylphenol and o-benzyl-p-chlorophenol. Useful antimicrobial agents known to be effective in preventing the visible growth of mildew colonies, include, for example, 3-iodo-2-propynl butylcarbamate, 2-(4-thiazolyl)benzimidazole, diiodomethyl-p-tolylsulfone, tetrachloroisophthalonitrile, the zinc complex of 2-pyridinethiol-1-oxide (including salts thereof) as well as combinations of the foregoing.

The coating composition comprising the antimicrobial agent offers protection against diverse microorganisms.

In one embodiment, the coating composition protects against Gram positive or Gram negative bacteria. Gram positive bacteria which are inhibited or killed by the coating include, but are not limited to, Mycobacterium tuberculosis, M. bovis, M. typhimurium, M. bovis strain BCG, BCG substrains, M. avium, M. intracellulare, M. africanum, M. kansasii, M. marinum, M. ulcerans, M. avium subspecies paratuberculosis, Staphylococcus aureus, S. epidermidis, S. equi, Streptococcus pyogenes, S. agalactiae, Listeria monocytogenes, L. ivanovii, Bacillus anthracis, B. subtilis, Nocardia asteroides, and other Nocardia species, Streptococcus viridans group, Peptococcus species, Peptostreptococcus species, Actinomyces israelii and other Actinomyces species, Propionibacterium acnes, and Enterococcus species. Gram negative bacteria which are inhibited or killed by the coating include, but are not limited to, Clostridium tetani, C. perfringens, C. botulinum, other Clostridium species, Pseudomonas aeruginosa, other Pseudomonas species, Campylobacter species, Vibrio cholerae, Ehrlichia species, Actinobacillus pleuropneumoniae, Pasteurella haemolytica, P. multocida, other Pasteurella species, Legionella pneumophila, other Legionella species, Salmonella typhi, other Salmonella species, Shigella species Brucella abortus, other Brucella species, Chlamydia trachomatis, C. psittaci, Coxiella burnetti, Escherichia coli, Neiserria meningitidis, N. gonorrhea, Haemophilus influenzae, H. ducreyi, other Haemophilus species, Yersinia pestis, Y. enterolitica, other Yersinia species, Escherichia coli, E. hirae and other Escherichia species, as well as other Enterobacteriacae, Brucella abortus and other Brucella species, Burkholderia cepacia, B. pseudomallei, Francisella tularensis, Bacteroides fragilis, Fusobacterium nucleatum, Provetella species, Cowdria ruminantium, Klebsiella species, and Proteus species. In another embodiment, the coating provides protection against fungi, including but are not limited to, Alternaria alternata, Aspergillus niger, Aureobasidium pullulans, Cladosporium cladosporioides, Drechslera australiensis, Gliomastix cerealis, Monilia grisea, Penicillium commune, Phoma fimeti, Pithomyces chartarum, and Scolecobasidium humicola.

The compositions useful for the present disclosure may also contain a first surfactant and a second surfactant. Suitable first surfactants have a preferred hydrophilic-lipophilic balance (HLB) of from about 9 to about 17. Suitable first surfactants include, but are not limited to: amphoteric surfactants, such as Amphoteric N from Tomah Products; silicone surfactants, such as BYK 348 available from BYK Chemie (Wesel, Germany); fluorinated surfactants such as Zonyl® FS300 from DuPont (Wilmington, Del., USA); and nonylphenoxy-polyethoxy-ethanol based surfactants, such as Triton N-101 available from Dow (Midland, Mich., USA). Other suitable first surfactants include ethoxylated decynediols such as Surfynol 465 available from Air Products & Chemicals (Allentown, Pa., USA); alkylaryl polyethers such as Triton CF-10 available from Dow; octylphenoxy polyethoxy ethanols such as Triton X-100 available from Dow; ethoxylated alcohols such as Neodol 23-5 or Neodol 91-8 available from Shell (The Hague, the Netherlands); Tergitol 15-S-7 available from Dow, Steol-4N, a 28% sodium laureth sulfate from Stepan Company (Northfield, Ill., USA), sorbitan derivatives such as Tween 20 or Tween 60 from Uniqema (New Castle, Del., USA), and quaternary ammonium compounds, such as benzalkonium chloride. Other suitable first surfactants include organo-silicone surfactants such as Silwet®L-77 from Setre Chemical Company (Memphis, Tenn., USA), DowCorning® Q2-5211 from DowCorning Silicones (Midland, Mich., USA), or Silsurf® A008 by Siltech Corporation (Toronto, ON, Canada). The preferred range for use of the first surfactant is from about 0.001 to about 5 wt % of the formulation, and more preferably from about 0.01 to about 1 wt %.

The second surfactant increases the antimicrobial activity of the coating composition and provides a synergistic effect in combination with the antimicrobial agent in the coating composition of the present invention. Suitable second surfactants are alkylbenzenesulfonic acid such as Biosoft® S101; amineoxide surfactants such as lauryl-dimethylamine oxide; alcohol ethoxylates such as ethoxylates of the general formula R—O(CH₂CH₂O)ₘH with “m” ranging from about 2 to 20 and “R” indicating a linear or branched alkyl group.

The second surfactant can be included in an amount of from about 0.001 to about 0.2 wt % of the formulation, and more preferably from about 0.005 to about 0.05 wt %.

Inert solvents useful for the current disclosure include water, and alcohols preferably containing from about 1 to about 6 carbon atoms and from 1 to about 6 hydroxy groups. Examples include ethanol, isopropanol, n-propanol, 1,2-propanediol, 1,2-butanediol, 2-methyl-2,4-pentanediol, mannitol and glucose. Also useful are the higher glycols, polyglycols, polyoxides, glycol ethers and propylene glycol ethers. Additional solvents include the free acids and alkali metal salts of sulfonated alkylaryls such as toluene, xylene, cumene and phenol or phenol ether or diphenyl ether sulfonates; alkyl and dialkyl naphthalene sulfonates and alkoxylated derivatives.

Additional components that may be added to the coating composition include colorants, rheology modifiers, cross-linking agents, plasticizers, surfactants, solubilizing agents, antioxidants, pH adjusters, wetting agents, antifoaming agents, extenders, lubricants, processing aids, color fastness agents, and additional performance-enhancing agents. Wetting agents lower the surface tension of the formulation to allow it to wet the surfaces, spread on the surfaces and potentially penetrate into, under, and around soils, solid matter, microorganisms, biofilms, surface contaminations, fat and surface crevices.

Colorants useful for the present disclosure include dyes and pigments such as food grade pigments. Dyes useful for the current disclosure are summarized in the commonly owned and co-pending U.S. Patent Applications Nos. 2008/0026026 and 2007/0275101.

The present disclosure may optionally include cross-linking agents. Suitable crosslinking agents are summarized in the commonly owned and co-pending U.S. Patent Applications Nos. 2008/0026026 and 2007/0275101.

It is important for flexibility and integrity of the protective film that the resultant film be plasticized. Plastization of the film has been accomplished for the purposes of this disclosure by incorporation of a suitable plasticizing agent such as polyethylene glycol or glycerol. Other plasticizers suitable plasticizers are summarized in the commonly owned and co-pending U.S. Patent Applications Nos. 2008/0026026 and 2007/0275101.

In addition to the foregoing components, the composition of the present disclosure can also comprise one or more performance enhancing additives also known as “performance enhancers”. These include flash rust inhibitors, which include any of a number of organic or inorganic materials used in a water-based system to prevent rust from forming on contact with the material and bare metal. One example is sodium benzoate.

Another optional performance enhancing additive is one or more of an array of defoamers recommended for water-based systems, to prevent unwanted foaming (gas bubbles) of the product during application or after formation of the film or coating. Too much foam can disrupt the required continuous film formation of the product and result in product failure. It can also be advantageous to add a foam control product, to aid in mixing and processing the masking composition, such as Drewplus L475 from Ashland Chemical, Inc., Drew Industrial Division (Covington, Ky., USA). Furthermore, the liquid coating composition of the current disclosure may be applied in the form of a foam to a locus whereby the composition serves as a temporary visual indicator that the surface has been covered. By the action of an antifoaming agent, the foam or gas bubbles are broken down, which is indicative of a dried film or coating. Thus, the antifoaming agent can be used in accordance with the current disclosure as an indicator by an operator, letting the operator know that the film or coating has dried.

Additional optional performance enhancing additives are antioxidants to increase the shelf life of the coating formulation. One example is butylated hydroxytoluene. Additional additives include fragrances.

Foaming agents can additionally be added to create gas bubbles in the applied coating. Gas bubbles can function as an opacifying agent to facilitate the application and/or to allow for longer contact time with a surface e.g., by preventing dripping from an inclined surface and/or to reduce the amount of coating formulation needed to treat a certain surface area or volume.

Application indicators may also be added. Some of these are described above, but include pigments, dyes, fluorescent dyes or gas bubbles generated during application.

Small amounts (typically less than 1 percent by weight) of these additional materials may be added with an appropriate adjustment of the water or other components. It is to be understood that mixtures of any one or more of the foregoing optional components can also be employed.

For loci comprised of fibrous substrates, an optional performance-enhancing ingredient is an agent that provides a surface effect. Such surface effects include no iron, easy to iron, shrinkage control, wrinkle free, permanent press, moisture control, softness, strength, anti-slip, antistatic, anti-snag, anti-pill, stain repellency, stain release, soil repellency, soil release, water repellency, oil repellency, odor control, antimicrobial, or sun protection,

Systems useful for combining multiple active components are known in the art. For example, multiple active fluids (liquid-liquid) systems typically use multi-chamber dispenser bottles or two-phase systems as described in U.S. Patent Application Pub. No. 2005/0139608; U.S. Pat. No. 5,398,846; U.S. Pat. No. 5,624,634; U.S. Pat. No. 6,391,840; E.P. Patent No. 0807156B1; U.S. Patent Appl. Pub. No. 2005/0008526; and PCT Publication No. WO 00/11713A1. Such systems can be suitable for use in the practice of the present invention.

The film or coating may be applied to the target surface or locus by any means, including pouring. The film or coating is applied to achieve a continuous and/or homogenous layer on a target surface. Coating systems routinely used for paints and coatings, such as, but not limited to, brushes, rollers, paint pads, mats, sponges, combs, hand-operated pump dispensers, compressed air operated spray guns, airless spray guns, electric or electrostatic atomizers, backpack spray application equipment, aerosol spray cans, clothes, papers, feathers, styluses, knives, and other applicator tools can be used for coating. If dipping is used as a method to apply the coating, no special equipment is required. If an aerosol spray can is used for application, the coating composition can be mixed with an aerosol propellant (such as a compressed gas) or the coating composition can be physically separated from the propellant by a barrier material such as a polymer bag inside the can; if the coating composition and the propellant are mixed the mixture can constitute one or more liquid phases.

For fibrous substrates, such as textiles and carpets, the coating can be applied by exhaustion, foam, flex-nip, nip, pad, kiss-roll, beck, skein, winch, liquid injection, overflow flood, roll, brush, roller, spray, dipping, immersion, and the like. The coating can also be applied by use of the conventional beck dyeing procedure, continuous dyeing procedure or thread-line application.

In one embodiment of the current disclosure, electrostatic sprayers can be used to coat the surface. Electrostatic sprayers impart energy to the aqueous coating composition via a high electrical potential. This energy serves to atomize and charge the aqueous coating composition, creating a spray of fine, charged particles. Electrostatic sprayers are readily available from suppliers such as Tae In Tech Co., South Korea and Spectrum, Houston, Tex., USA. Generally, the coating is allowed to set or dry for about greater than 5 minute. However, the coating may be antimicrobially effective in a shorter time-frame, such as after 30 seconds. The coating may be removed before it is dried or anytime thereafter depending on the desired use. The drying time will be partially dependent on a number of factors, including environmental conditions such as humidity and temperature. The drying time will also depend on the thickness of the applied coating.

In another embodiment of the current disclosure, an airless spray system can be used to coat the target surface. Airless spray systems use high fluid pressures and special nozzles, rather than compressed air, to convey and atomize the liquid. The liquid is supplied to an airless gun by a fluid pump at pressures typically ranging from 3.5 to 45 MPa. When the paint exits the fluid nozzle at this pressure, it expands slightly and atomizes into tiny droplets without the impingement of atomizing air. The high velocity of the exiting paint propels the droplets toward the target surface. The fluid nozzle on an airless gun differs substantially from the fluid nozzle on an air atomized gun. Selection of the proper nozzle determines how much paint is delivered and the fan pattern of application. The size of the airless nozzle orifice determines the quantity of paint to be sprayed. Airless fluid delivery is high, typically ranging from 700 to 2000 mL/min. Recommended gun distance is about 30 cm from the target, and depending upon the nozzle type, a fan pattern of 10 to 45 cm is possible. Thus, nozzles can be selected for each application based on the size and shape of the target surface and the thickness of the coating to be applied. Airless guns create little air turbulence that can repel the liquid from “hard to reach areas”, such as would be found in food processing equipment, hatcheries etc. The high flow rate makes airless advantageous in cleaning and disinfecting situations, where the antimicrobial coating is to be applied over a large surface area and multiple surfaces. The thickness of the applied and dried film will depend on a variety of factors. These factors include the concentration of the film forming agent, the concentration of rheology control additives and/or other additives, as well as the application temperature and humidity. Film thickness and film uniformity also depend, at least in part, on parameters of the application equipment, such as fluid delivery, spray orifice diameter, air pressure or piston pump pressure in the case of airless application, and the distance of the spray applicator to the target surface. Therefore, the liquid formulation may be adjusted to yield the desired film thickness.

The atomization of the coating solution is chosen such that a thin film is applied homogeneously to the target area.

Target surfaces (loci) include all surfaces that may potentially be contaminated with microorganisms, including surfaces typically difficult to apply a disinfectant or sanitizer to (such as hard-to-reach surfaces). Examples of target surfaces include equipment surfaces found in the food or beverage industry (such as tanks, conveyors, floors, drains, coolers, freezers, refrigerators, equipment surfaces, ceilings, walls, valves, belts, pipes, drains, ductwork, joints, crevasses, combinations thereof, and the like); building surfaces, including buildings under construction, new home construction, and surfaces in or on seasonal properties like vacation home surfaces (such as ceilings, walls, wood frames, floors, windows, ductwork), kitchens (sinks, drains, counter-tops, refrigerators, cutting boards), bathrooms (showers, toilets, drains, pipes, ductwork, bath-tubs), (especially for mold removal), decks, wood, siding and other home exteriors, asphalt shingle roofing, patio or stone areas (especially for algae treatment); boats and boating equipment surfaces; garbage disposals, garbage cans and dumpsters or other trash removal equipment and surfaces; non-food-industry related pipes and drains; surfaces in hospital, surgery or out-patient centers or veterinary surfaces (such as ceilings, walls, floors, ductwork, beds, equipment, clothing worn in hospital/veterinary or other healthcare settings, including scrubs, shoes, and other hospital or veterinary surfaces) first-responder or other emergency services equipment and clothing; lumber-mill equipment, surfaces and wood products; restaurant surfaces; supermarket, grocery, retail and convenience store equipment and surfaces; deli equipment and surfaces and food preparation surfaces; brewery and bakery surfaces; bathroom surfaces such as sinks, showers, counters, and toilets; clothes and shoes; toys; school and gymnasium equipment, ceilings, walls, floors, windows, ductwork and other surfaces; kitchen surfaces such as sinks, counters, appliances; wooden or composite decks, pool, hot tub and spa surfaces; carpet; paper; leather; animal carcasses, fur and hides; surfaces of barns, or stables for livestock, such as poultry, cattle, dairy cows, goats, horses and pigs; and hatcheries for poultry or for shrimp. Surfaces within structures wherein animals are housed, such as cages and pens for example, can be coated using the antimicrobial coatings described herein. Additional surfaces also include food products, such as beef, poultry, pork, vegetables, fruits, seafood, combinations thereof, and the like.

Additional loci suitable for use in the present invention comprise fibrous substrates and include fibers, yarns, fabrics, textiles, nonwovens, carpets, leather, or paper. The fibrous substrates are made with natural fibers such as wool, cotton, jute, sisal, sea grass, paper, coir and cellulose, or mixtures thereof; or are made with synthetic fibers such as polyamides, polyesters, polyolefins, polyaramids, acrylics and blends thereof; or blends of at least one natural fiber and at least one synthetic fiber. By “fabrics” is meant natural or synthetic fabrics, or blends thereof, composed of fibers such as cotton, rayon, silk, wool, polyester, polypropylene, polyolefins, nylon, and aramids such as “NOMEX®” and “KEVLAR®.” By “fabric blends” is meant fabric made of two or more types of fibers. Typically these blends are a combination of at least one natural fiber and at least one synthetic fiber, but also may be a blend of two or more natural fibers or of two or more synthetic fibers. Nonwoven substrates include, for example, spunlaced nonwovens, such as SONTARA available from E. I. du Pont de Nemours and Company (Wilmington, Del., USA), and laminated nonwovens, such as spunbonded-meltblown-spunbonded nonwovens.

Examples of surface materials are metals (e.g., steel, stainless steel, chrome, titanium, iron, copper, brass, aluminum, and alloys thereof), minerals (e.g., concrete), polymers and plastics (e.g., polyolefins, such as polyethylene, polypropylene, polystyrene, poly(meth)acrylate, polyacrylonitrile, polybutadiene, poly(acrylonitrile, butadiene, styrene), poly(acrylonitrile, butadiene), acrylonitrile butadiene; polyesters such as polyethylene terephthalate; and polyamides such as nylon). Additional surfaces include brick, tile, ceramic, porcelain, wood, vinyl, and linoleum.

Equipment or surfaces protected with a temporary coating may be in use or not in use while protected. The target surface may be hydrophobic or hydrophilic.

Generally, the coating is allowed to set or dry for about 5 to about 60 minutes in order to form the film. The present composition, when applied onto a surface, will form a film or a coating by evaporation of the inert solvent. The solvent evaporation could occur by allowing the coating to dry in place, or alternatively by blowing dry with heated or unheated air. However, the coating may be effective as an antimicrobial agent in a shorter time-frame, such as after 30 seconds. The coating may be removed before it is dried or anytime thereafter depending on the desired use. The drying time will be partially dependent on a number of factors, including environmental conditions such as humidity and temperature. The drying time will also depend on the thickness of the applied coating.

### Film or Coating Thickness

The thickness of the film or coating applied onto the target surface influences the time needed for removal and the amount of biocide per unit area applied to the surface. Thicker films increase the time interval until the film has to be re-applied to maintain the desired antimicrobial properties. Thinner films will be easier and faster to remove by rinsing. It is thus important to apply the formulation in a fashion that results in a film thickness that allows both easy removal of the coating and long-lasting antimicrobial properties. The film or coating has a thickness of about 0.3 to about 300 micrometers. In a more specific embodiment, the film or coating has a thickness of about 0.5 to about 100 micrometers. In an even more specific embodiment, the film or coating has a thickness of about 1.0 to about 30 micrometers.

The method of the present disclosure is directed to application of antimicrobial films that may be removed at a time determined appropriate by the user. The time of removal may be determined by either (i) the desired minimum contact time to allow for the desired antimicrobial activity, typically expressed as amount of killed or inactivated microorganisms out of a starting population or (ii) the need or desire to take the coating off the surface before starting a subsequent operation or process step. Although the coating may be removed at any time, such as after drying, the film thickness, concentration of antimicrobial agent, and specific use determines the appropriate time for removal. For instance the user may wish to put treated equipment back into normal operation after a period of operational shutdown.

Film removal may be achieved by dissolution or dispersion of the resulting coating. This may be achieved by the application an aqueous solution onto the coating. In one embodiment, the temperature of the solution is in the range of about 5° C. to about 100° C. In another embodiment, the temperature of the solution is from about 10 to about 80° C. The application of the solution, or water, may be achieved by a simple rinse or spray onto the surface. Coating removal may also be achieved by use of a pressure washer, facilitating removal by additional mechanical forces. Coating removal may also be achieved by washing with water together with a cloth or sponge. Further, mild additives may be utilized or mixed with the aqueous solution to help solubilize or disperse the film-forming or water-dispersible agents, including commonly used acids or bases, chelators or detergents. Alternatively, the film may be degraded, such as in a drain, by repeated washing of water and/or other components down the drain. The film may also be removed by peeling it off a surface, being abraded or brushed from the surface, or other mechanical mechanisms of removal.

Besides the intentional removal by an operator, removal also includes the removal by an automated or robotic system and the non-intentional removal by a liquid continuously or periodically contacting the coating over time, e.g., in a pipe or drain, or by continuous or periodical application of mechanical forces, such as wear.

An aqueous solution used for coating removal is any solution containing 60 to 100 wt % water, the remaining components being dissolved components. Dissolved components may include but are not limited to solvents such as alcohols, solubilizing agents, surfactants, salts, chelators, acids and bases.

While the methods and compositions of the present disclosure have been described in terms of various aspects of the current disclosure and preferred embodiments, it will be apparent to those of skill in the art that variations may be applied to the compositions and methods and in the steps or in the sequence of steps of the disclosure described herein without departing from the concept, spirit, and scope of the current disclosure. More specifically, it will be apparent that certain agents, which are chemically related, may be substituted for the agents described herein while the same or similar results would be achieved. All such similar substitutes and modifications apparent to those skilled in the art are deemed to be within the spirit, scope, and concept of the current disclosure as defined by the appended claims.

### EXAMPLES

The present disclosure is further defined in the following Examples. It should be understood that these Examples, while indicating certain preferred embodiments of the disclosure, are given by way of illustration only. From the above discussion and these Examples, one skilled in the art can ascertain the essential characteristics of this disclosure, and without departing from the spirit and scope thereof, can make various changes and modifications of the disclosure to adapt it to various uses and conditions.

### Abbreviations and Other Terms Used in the Examples

“ATCC” means American Type Culture Collection; “° C.” means degrees Celsius; “CFU” means colony forming unit; “rpm” means revolution per minute; “mol/L” means mole per liter; “PFU/mL” means plaque forming units per milliliter; “kg” means kilogram; “DI” means deionized; “FBS” means fetal bovine serum; “g” means earth gravitational constant; “L” means liter; “log CFU” is the base-10 logarithm of the CFU number; “log CFU” is the difference of log CFU for an untreated sample and log CFU for a samples treated with a coating composition; “mL” means milliliter; “MPa” means Megapascal; “NFC” means non-food contact sanitizer test; “Pa” means Pascal; “Pa·s” means Pascal seconds; “PEG” means polyethylene glycol; “PFU” means plaque forming unit; “rpm” means revolutions per minute; “RSS” means residual self-sanitizing activity; “s⁻¹” means seconds to the minus first power; “SS316” means stainless steel, type 316 (ASTM standard); “wt %” means weight percent.

### Chemicals

All chemicals were obtained from Sigma-Aldrich (St. Louis, Mo., USA) unless stated otherwise. Alcogum® L-520 was obtained from Alco Chemical® (Chattanooga, Tenn., USA). Elvanol® 51-04 was from DuPont (Wilmington, Del., USA). Polyethylene glycol (PEG-300) was from Dow (Midland, Mich., USA). FD&C Blue No. 1 dye was from Pylam Products (Tempe, Ariz., USA). BTU) 885 and Biosoft® N25-7, Biosoft® S101 and Biosoft® ET-650 were from Stepan (Northfield, Ill., USA). Surfynol® MD-20 and EnviroGem® 360 were from AirProducts (Allentown, Pa., USA). Barlox® 12 was from Lonza (Basel, Switzerland). Bacto™ D/E neutralizing broth was from Difco (Cat. No. 281910, Difco™ Laboratories, Detroit, Mich., USA).

### General Methods

### Test Methods for Antimicrobial Efficacy on Hard Surfaces

Biocidal or antimicrobial efficacy of the coating compositions according to this disclosure was measured using the test methods described below:

Non-food contact sanitizer (NFC) test: To assess the antimicrobial activity of coating compositions according to this disclosure for situations where microbial contamination is already present on the target surface at the time of the application of the antimicrobial coating composition the “Standard Test Method for Efficacy of Sanitizers Recommended for Inanimate Non-Food Contact Surfaces” according to ASTM standard E1153-03 was used. The test method is referred to as non-food contact sanitizer test or NFC test. Results are reported as log CFU which indicates the difference of log CFU for inoculated, untreated control coupons and log CFU for coupons treated with the coating compositions according to the method provided herein. The log CFU numbers for both control and treated coupons were calculated as the geometric mean of the number of microorganisms surviving on replicate coupons. All log numbers are base-10 logarithms.
Residual self-sanitizing (RSS) test with bacteria: To assess the antimicrobial activity of coating compositions according to this method for situations where microbial contamination comes into contact with the already dry coating, the following residual self-sanitizing test method was used. The test method is referred to as residual self-sanitizing test or RSS test. 25.4 mm×25.4 mm, non-porous, pre-cleaned, stainless steel (type SS316) coupons were used for the test. The test microorganism was transferred from a frozen stock culture to a tube of the culture medium. The tube was incubated for a duration and temperature that provides good growth. The inoculum was maintained by consecutively transferring to the fresh culture medium. The approximately 48 hour old inoculation suspensions were mixed for approximately 3 seconds and let stand for 15 minutes. The inoculum suspension typically contained approximately 1×10⁸ CFU/mL. The upper two-thirds of the total inoculum volume was decanted or pipetted off and transferred into a fresh sterile tube. A volume of sterile FBS was added to yield a 5 wt % organic soil load. The inoculum was left at room temperature for about 15 minutes.

The test coupons were cleaned using a mild detergent, then alcohol, and rinsed thoroughly in sterile water and allowed to air dry. All handling of surfaces, once cleaned, was done using sterile forceps. Coupons were immersed in 70 wt % ethanol for 30 minutes and allowed to dry completely. 0.05 to 0.1 mL of the coating composition to be tested was applied to each stainless steel coupon and spread evenly. The coating compositions were allowed to dry at room temperature overnight. Control surfaces were untreated coupons handled under the same conditions as the coupons treated with the coating compositions or coupons that were treated with a coating composition that contained no antimicrobial agent.

Coupons were inoculated by spotting 0.01 mL of the inoculum over the surface of the coupon. Two coupons were inoculated per coating composition. After 5 minutes contact time (or other appropriate time), the inoculation sterile forceps were used to transfer the coupons to 20 mL of neutralizer broth in a 50 mL test tube. The samples were sonicated for 20 seconds in a sonicating water bath, then agitated on an orbital shaker for 3-4 minutes at 250 rpm. All samples were serially diluted in duplicate in phosphate buffered dilution water and all samples were streaked on plates within approximately 30 minutes of their transfer to the Bacto™ neutralizing broth.

Results are reported as log CFU which indicates the difference of log CFU for inoculated, untreated control coupons and log CFU for coupons treated with the coating compositions according to this disclosure. The log CFU numbers for both control and treated coupons were calculated as the geometric mean of the number of microorganisms surviving on replicate coupons. All log numbers are base-10 logarithms.

Residual self-sanitizing (RSS) test with fungal spores: To assess the antimicrobial activity of coating compositions according to this disclosure for situations where a fungal contamination comes into contact with the already dry coating the following residual self-sanitizing test method was used. The test method is referred to as residual self-sanitizing test or RSS test. 25.4 mm×25.4 mm, non-porous, pre-cleaned, stainless steel (type SS316) coupons were used for the test. The test microorganism used in this study was Trichophyton mentagrophytes ATCC 9533. Potato Dextrose Agar (PDA) plates were used. Twenty plates were streaked with one of the cultures and incubated for 2 weeks at room temperature. Plates were then washed twice with sterile DI water containing 0.01 wt % Tween® 80, and scraped with a sterile spreader. The washes were combined into a sterile flask with glass beads, and shaken on a wrist action shaker for 1 hour. The flask contents were then filtered through sterile gauze into a new sterile flask and stored at 4° C. The concentration of viable fungal spores was determined by standard plate count methodology using serial dilutions in sterile phosphate buffer and spreading onto PDA plates. The PDA plates were incubated for 4 days before the colonies were counted. Before the start of the test, 24 mL of the spore preparation was centrifuged for 10 min at 5000·g. The supernatant was removed and the pellet was resuspended in 8 mL of sterile DI water containing 0.01% Tween® 80. An aliquot (4.75 mL) of the concentrated spore preparation was removed and mixed with 0.25 mL of fetal bovine serum (final concentration of 5 wt %) to produce the inoculum.

The test coupons were washed with detergent and rinsed with water. The coupons were then rinsed in 70 wt % ethanol and allowed to air dry in a Petri dish containing sterile Whatman 2 filter paper. Right before use, the coupons were sprayed with 70 wt % ethanol and allowed to dry. The liquid coating formulation to be tested was separately applied in 50 μL volumes and spread to coat most of the coupon. The coupons were then dried for 24 hours at room temp (25° C.) at 50% relative humidity (RH). Control surfaces were untreated coupons handled under the same conditions as the coupons treated with the coating compositions.

Ten microliters of the inoculum was applied to each coupon in 30 aliquots, making sure that each aliquot was in contact with the dry coating, if present. The inoculum was exposed to the coupons for the specified contact time at room temperature and 50% RH. After a given contact time, each coupon was placed in 20 mL of DE neutralizing broth and sonicated for 10 seconds. The broth tubes were then incubated for 4 minutes on an incubator shaker at 250 rpm. An aliquot (0.1 mL) was removed from each broth tube and serially diluted in sterile phosphate buffer. An aliquot (0.1 mL) was removed from each dilution and broth tube and plated on PDA. The PDA plates were incubated at room temperature for 4 days and counted. Each combination of inoculum, contact time, and coating treatment was tested in triplicate. As a control, coupons without a coating were also inoculated and processed as described above. Based on plate counts of the appropriate dilution, the concentration of viable fungal spores was determined. This number was multiplied by 20 to determine the CFU/carrier. The CFU/carrier values were converted to base-10 log numbers and the means calculated from the three replicates. Log reductions were determined by subtracting the mean log (CFU/carrier) for the treated samples from the mean log (CFU/carrier) for the control (no treatment) samples held at the same contact time.

To verify the effectiveness of the neutralizing broth, a series of dilutions were prepared from the test inoculum and spread on PDA plates. A 1.0 mL aliquot from the 10⁻⁵ dilution was removed and added to two separate 20 mL DE broth tubes containing a coupon coated with 50 μL of the liquid coating composition. Each broth tube was agitated vigorously with a Vortex mixer and an aliquot (0.1 mL) was removed and spread on a PDA plate. The PDA plates were incubated as described above.

Results are reported as log CFU which indicates the difference of log CFU for inoculated, untreated control coupons and log CFU for coupons treated with the coating compositions according to this disclosure. The log CFU numbers for both control and treated coupons were calculated as the geometric mean of the number of microorganisms surviving on replicate coupons. All log numbers are base-10 logarithms.

Test with bacterial viruses (bacteriophage surrogate test): To assess the antiviral efficacy of coating compositions, a procedure using bacteriophage T4 was employed. Bacteriophage T4 is similar to a variety of pathogenic human or animal viruses in terms of its resistance to treatment with sanitizers. It is used as a surrogate for pathogenic human or animal viruses because it is simple to propagate and does not require the use of tissue culture for recovery.

Stocks of bacteriophage T4 were prepared by infecting lawns of the host bacteria Escherichia coli ATCC 11303 on trypticase soy agar plates (BBL, Sparks, Md., USA). Phage buffer was prepared by dissolving NaCl (5.8 g) and MgSO₄.7H₂O (2.0 g) in 800 mL of DI water, then adding 50 mL of Tris-HCl solution (1 mol/L, pH 7.5) and 5 mL gelatin solution (20 g/L) and then adjusting the total volume to 1 liter with DI water. The phage buffer was then sterilized by autoclaving for 20 minutes at 0.2 MPa pressure. After the solution had cooled, 50 mL aliquots were stored into sterile containers. Following overnight incubation at 37° C., phage were recovered by washing with phage buffer and stored at 4° C. until use. The titer of the phage stocks was generally between 10⁹ to 10¹⁰ PFU/mL. To perform the test, 10 microliters of phage stock (diluted 1:100) containing 5 wt % fetal bovine serum (Aleken Biologicals, Texarkana, Ark., USA) was deposited onto a sterile round glass cover slip of 18 mm diameter contained within the wells of a 12-well microtiter plate and allowed to dry. The host strain (Escherichia coli ATCC 11303) was cultured overnight in Luria broth (Difco, Sparks, Md., USA) containing 0.01 mol/L MgSO₄. The liquid coating composition (0.25 mL) was pipetted on top of the dried film of the T4 phage and incubated at 25° C. for 30 minutes. The activity of the coating composition was then neutralized by the addition of 1 mL of Letheen broth (Difco, Sparks, Md., USA) supplemented with 0.5 wt % sodium thiosulfate. The cover slips containing dried, treated phage and Letheen broth were then scraped using sterile tissue-culture scrapers to suspend the phage in the neutralizer. The neutralized mixture was then diluted into phage buffer. Dilutions (0.1 mL) of treated bacteriophage were mixed with 0.3 mL of the host strain and incubated for 30 minutes at 37° C. These dilutions were then mixed with 3 mL of molten “top” agar (trypticase soy broth containing 0.7 wt % agar, Difco, Sparks, Md., USA) and poured immediately onto plates of trypticase soy agar. Plates were incubated overnight at 37° C. prior to enumerating the number of plaques.

### Example 1

### Coating Compositions Comprising Various Acids

A stainless steel tank (type SS316) that was equipped with a dual-blade impeller and two external band heaters was used to manufacture the removable antimicrobial coating composition #248. The clean tank was loaded with 15.59 kg of water at 20° C. The dual blade mixer was started at a speed of 200 rpm to provide a significant vortex equal to half of vessel depth. Surfynol® MD₂O (156 grams) was added followed by 3.74 kg of Elvanol® 51-04 at a rate of 0.5 kg per minute. The mixture was agitated for 10 minutes before turning on the band heaters. The mixture temperature was monitored via the digital temperature sensor. The mixture was heated until the temperature sensor reached 65-67° C. The heaters were turned off and the temperature was allowed to drop to 55° C. over 40 minutes. Water (8.8 kg, 7° C.) was added followed by 155.9 grams of the Envirogem®360, and 311.7 grams of PEG-300. To this mixture, 93.5 grams of the BTC®885 was added followed by 6.3 of a 5 wt % solution of FD&C Blue No. 1. The acid-swellable rheology agent Alcogum® L-520 was mixed well and then 2182 grams of it was added to the mixture. The pH of the mixture was 7.1. Then, a 10 wt % acetic acid solution was added until the pH had reached 5.5. The pH was monitored using a pH meter (VWR SP70P pH meter). After the addition of the acid the mixture thickened quickly. The mixture was filtered using filter bags with 100 micrometer pore size and stored in high-density polyethylene pails.

Similar coating compositions as described above were also made using the same process as described above but different amounts of ingredients and/or different type of acid to activate the rheology agent. Table 1 shows the compositions used in subsequent Examples.

TABLE 1
Coating compositions

| | Concentration (wt %) | | | |
|---|---|---|---|---|
| | Coating | Coating | Coating | Coating |
| | composition | composition | composition | composition |
| Ingredient | #248 | #261 | #271 | #B154C |
| Elvanol ® | 12 | 12 | 10 | 10 |
| 51-04 | | | | |
| Envirogem ® | 0.5 | 0.5 | 0.5 | 0.5 |
| 360 | | | | |
| Biosoft ® | — | — | 0.01 | 0.01 |
| N25-7 | | | | |
| Surfynol ® | 0.5 | 0.5 | 0.2 | 0.2 |
| MD-20 | | | | |
| BTC ® 885 | 0.3 | 0.3 | 0.3 | 0.3 |
| PEG-300 | 1.0 | 1.0 | 1.0 | 1.0 |
| Alcogum ® | 7.0 | 6.0 | 6.0 | 0.3 |
| L-520 | | | | |
| Acetic acid | 0.18 | — | — | — |
| Lactic acid | — | 0.20 | — | — |
| Glycolic acid | — | — | 0.25 | 0.012 |
| FD&C Blue | 0.01 | 0.01 | 0.01 | 0.01 |
| No. 1 | | | | |
| Water | rem | rem | rem | rem |

“rem” indicates “remainder to 100 wt %”

### Example 2

### Short-Term Antimicrobial Properties

The coating composition #248 of Example 1 was tested for short-term antimicrobial activity using the NFC method described above. The NFC method assesses the antimicrobial activity of the coating composition while it is still liquid. The test microorganisms used were Staphylococcus aureus ATCC 6358, Enterobacter aeruginosa ATCC 13048 and Pseudomonas aeruginosa ATCC 15442. As shown in Table 2, a more than 4.8 log reduction was achieved for S. aureus which is equivalent to reduction of the CFU number by more than 99.998%. For E. aeruginosa and P. aeruginosa as test microorganisms, log CFU numbers of 3.8 and 4.2, respectively, were achieved.

TABLE 2
Short-term antimicrobial properties of
composition #248 according to NFC method

| Coating | Test | Test | Contact | |
|---|---|---|---|---|
| composition | method | microorganism | time | Log CFU |
| #248 | NFC | S. aureus | 5 min | >4.8 |
| #248 | NFC | E. aerogenes | 5 min | 3.8 |
| #248 | NFC | P. aeruginosa | 5 min | 4.2 |

### Example 3

### Residual Antimicrobial Activity

The coating composition #248 of Example 1 was tested using the residual self-sanitizing (RSS) test method and Staphylococcus aureus ATCC 6358 as the test microorganisms. Results summarized in Table 3 indicate log CFU values of at least 4.8 in 5 minutes contact time for composition #248.

TABLE 3
Residual antimicrobial activity of composition
#248 according to RSS method

| | Coating | Test | Test | Contact | |
|---|---|---|---|---|---|
| Test | composition | method | microorganism | time | Log CFU |
| 1 | #248 | RSS | S. aureus | 5 min | >4.8 |
| 2 | #248 | RSS | S. aureus | 5 min | >4.8 |

### Example 4

### Residual Antifungal Properties

The coating composition #271 of Example 1 was tested for residual activity against fungal spores using the RSS method. The RSS method assesses the antimicrobial activity of the coating composition after it has dried. The test microorganism used was Trichophyton mentagrophytes ATCC 9533. The low-level detection limit for this test was 200 CFU/carrier or a log CFU number of 2.30. As shown in Table 4, after either 30 or 60 min contact times there were no viable plate counts. This is equivalent to a greater than 2.69 and 2.82 log reduction number (i.e., a reduction in the CFU number by greater than 99.8% for the 30 and 60 min contact times).

TABLE 4
Antifungal activity of coating composition
#271 according to the RSS method

| Coating | Contact | |
|---|---|---|
| composition | time | Log CFU |
| #271 | 30 min | >2.69 |
| #271 | 60 min | >2.82 |

### Example 5

### Antiviral Properties

Coating composition #248 of Example 1 was tested for its ability to inactivate bacteriophage T4 using the bacteriophage surrogate test outlined above. The bacteriophage surrogate test measures the activity of the liquid coating composition upon application to a dried film of phage particles. The level of bacteriophage was reduced by 2.8-2.9 log PFU equivalent to a reduction of more than 99.8% using coating composition #248 and a 30 minute contact time.

### Example 6

### Rheological Properties of Coating Compositions

The rheological properties of the liquid antimicrobial formulations were assessed using a rotational rheometer, running ascending and descending flow curves. The rheometer used was a Brookfield HADV-III+(Brookfield Engineering, Middleboro, Mass., USA) with a Couette flow geometry, small sample adapter, spindle SC4-21 and sample chamber 13RP. The temperature was kept constant with a thermostat bath. Samples were loaded by pouring or scooping into the Brookfield sample holder. Viscosity measurements were taken at different rpm.

The viscosities of coating composition #248 of Example 1 were measured at varying shear rates (Table 5). The data shows a decrease in viscosity with increasing shear rate for both temperatures examined, highlighting the pseudoplastic properties of the coating composition.

TABLE 5
Viscosity of coating composition #248
at various temperatures and shear rates

| Shear rate | Temperature | Viscosity |
|---|---|---|
| (s⁻¹) | (° C.) | (Pa · s) |
| 1 | 25 | 3.45 |
| 10 | 25 | 1.18 |
| 100 | 25 | 0.48 |
| 1000 | 25 | 0.24 |
| 1 | 5 | 16.0 |
| 10 | 5 | 3.90 |
| 100 | 5 | 1.18 |
| 1000 | 5 | 0.55 |

### Example 7

### Shear-Thinning Index

The “pseudoplastic index” or “shear-thinning index” (STI) provides an indication of the resistance of the composition to sagging and dripping. A common measurement determines the viscosity at two different shear rates such as 1 s⁻¹ and 10 s⁻¹. The value recorded at the lower shear rate is divided by the value at the higher shear rate obtain the STI. Generally, the higher the STI, the higher the resistance to sagging and dripping the coating material will have.

The shear-thinning index (STI) was calculated by dividing the viscosity measured at 1 s⁻¹ by the viscosity measured at 10 s⁻¹. The STI values for coating composition #248 of Example 1 are given in Table 6. As can be seen from the table, the STI values in the temperature range between 5° C. and 25° C. are between about 2.9 and 4.1 which provides a high enough shear-thinning index to achieve a non-dripping and non-sagging film after application to a vertical surface, e.g., after spray application.

It is also worth noting that the shear-thinning index increases by lowering the temperature of the coating composition. This is of advantage for applications where the coating compositions will be used in cold environments such as food processing plants, cold rooms, etc., in which the coating composition will be even more resistant to sagging and dripping.

TABLE 6
Shear-thinning index of coating composition #248

| Temperature | Viscosity at | Viscosity at | |
|---|---|---|---|
| (° C.) | 1 s⁻¹ (Pa · s) | 10 s⁻¹ (Pa · s) | STI |
| 25 | 3.45 | 1.18 | 2.92 |
| 5 | 16.0 | 3.90 | 4.10 |

### Example 8

### Antimicrobial Properties of Coating Compositions Comprising Alpha-Hydroxy Acids

Antimicrobial properties of coating compositions containing alpha-hydroxy acids were tested using NFC and RSS methods.

The test results for both test methods for various test microorganisms for coating compositions #261 and #271 are summarized in Table 7.

The viscosity of coating composition #261 was measured at different shear rates. The viscosity of the composition decreases with increasing shear rate for both measurement temperatures indicating pseudoplastic properties of the coating composition (Table 8).

TABLE 7
Antimicrobial activity result for coating
compositions #261 and #271

| | | Test | Test | Contact | |
|---|---|---|---|---|---|
| Test | Coating | method | microorganism | time | Log CFU |
| 1 | #261 | NFC | S. aureus | 10 min | 3.4 |
| 2 | #261 | NFC | S. aureus | 30 min | 4.4 |
| 3 | #261 | NFC | P. aeruginosa | 30 min | 4.9 |
| 4 | #261 | NFC | E. aerogenes | 30 min | 3.8 |
| 5 | #261 | RSS | S. aureus | 5 min | 4.1 |
| 6 | #271 | NFC | S. aureus | 30 min | 4.3 |
| 7 | #271 | RSS | S. aureus | 5 min | 4.2 |
| 8 | #271 | RSS | S. aureus | 30 min | 4.2 |
| 9 | #271 | RSS | E. aerogenes | 30 min | 3.5 |
| 10 | #271 | RSS | P. aeruginosa | 30 min | 3.5 |

TABLE 8
Viscosities of coating composition #261

| Shear rate | Temperature | Viscosity |
|---|---|---|
| (s⁻¹) | (° C.) | (Pa · s) |
| 1 | 25 | 2.23 |
| 10 | 25 | 0.84 |
| 100 | 25 | 0.36 |
| 1000 | 25 | 0.19 |
| 1 | 5 | 10.5 |
| 10 | 5 | 2.81 |
| 100 | 5 | 0.89 |
| 1000 | 5 | 0.40 |

### Example 9

### Appearance of Surfaces after Removal of Coating

To study the appearance of surfaces coated with coating compositions #248, #261 and #271 after removal of the coating using a tap water rinse both aluminum and polycarbonate (Lexan® type 141R-701-BLK, dimensions 305 mm×102 mm×3.2 mm, General Electric Co., Fairfield, Conn., USA) panels were used as surfaces to coat. The panels were first coated with the liquid coating compositions using a wet film applicator (203 μm film depth, model AP-15SS, Paul N. Gardner Co. Inc., Pompano Beach, Fla., USA). The coatings were then allowed to dry in air for at least 24 hours. The dry coatings were washed off by rinsing with tap water of about 25° C. The panels were again allowed to dry in air and the appearance of the panels was analyzed for residues by eye and results are summarized in Table 9.

Whereas coating composition #248 left a clearly visible dull residue after the rinse on both surface materials tested, coating compositions #261 and #271 produced only a slight, hardly visible residue, thus highlighting that lactic acid and glycolic acid were preferred over acetic acid to activate the rheology agent.

TABLE 9
Appearance after coating removal by water rinse

Appearance of surface after
removal of coating

| Coating | Acid used in | Aluminum | Polycarbonate |
|---|---|---|---|
| composition | composition | panel | panel |
| #248 | Acetic acid | Clearly visible, | Clearly visible, |
| | | dull residue | dull residue |
| #261 | Lactic acid | Slight, hardly | Slight, hardly |
| | | visible residue | visible residue |
| #271 | Glycolic acid | Slight, hardly | Slight, hardly |
| | | visible residue | visible residue |

### Example 10

### Improved Residual Self-Sanitizing Activity of Coating Formulations with Added Nonionic Surfactant

The residual self-sanitizing properties according to the RSS test method were studied for the coating compositions given in Table 10. The coating compositions were applied to the coupons and dried in air for 22 hours at 24-25° C. and a relative humidity of 43-46%. Also given in the Table are the log reduction values for a contact time of 5 minutes using Staphylococcus aureus (ATCC 6358) as the test microorganism.

The comparison between composition #107E and #107F illustrates that the nonionic Envirogem® 360 surfactant significantly improved the antimicrobial performance according to this test by more than one log-unit.

The comparison between composition #107B and any of the compositions #107E, G, H and I showed that the addition of a second surfactant (Biosoft® S101, Barlox® 12, Biosoft® N25-7 and Biosoft® ET-650, respectively) at comparably low level (0.01 wt %) provided an additional increase in the residual self-sanitizing activity.

Biosoft® S101 is a linear alkyl benzene sulfonic acid; Barlox® 12 is a lauryl-dimethylamine oxide; Biosoft® N25-7 is an alcohol ethoxylate of the general formula CH₃(CH₂)ₙ—O(CH₂CH₂O)ₘH with “n” ranging from about 11 to 14 and an average value for m of about 7; Biosoft® ET-650 is a nonionic alcohol ethoxylate prepared by ethoxylation of fatty alcohol.

TABLE 10
Coating compositions with added nonionic surfactants and residual
self-sanitizing activity (shown as log CFU) against S. aureus

| | Concentration (wt %) | | | | | |
|---|---|---|---|---|---|---|
| | Coating | Coating | Coating | Coating | Coating | Coating |
| Ingredient | #107B | #107E | #107F | #107G | #107H | #107I |
| Elvanol ® | 10 | 10 | 10 | 10 | 10 | 10 |
| 51-04 | | | | | | |
| Envirogem ® | 0.5 | 0.5 | — | 0.5 | 0.5 | 0.5 |
| 360 | | | | | | |
| Surfynol ® | 0.2 | 0.2 | 0.2 | 0.2 | 0.2 | 0.2 |
| MD-20 | | | | | | |
| BTC ® 885 | 0.3 | 0.3 | 0.3 | 0.3 | 0.3 | 0.3 |
| Glycerin | 3.0 | 3.0 | 3.0 | 3.0 | 3.0 | 3.0 |
| Alcogum ® | 6.0 | 6.0 | 6.0 | 6.0 | 6.0 | 6.0 |
| L-520 | | | | | | |
| Glycolic acid | 0.25 | 0.25 | 0.25 | 0.25 | 0.25 | 0.25 |
| FD&C Blue | 0.01 | 0.01 | 0.01 | 0.01 | 0.01 | 0.01 |
| No. 1 | | | | | | |
| Biosoft ® | — | 0.01 | 0.01 | — | — | — |
| S101 | | | | | | |
| Barlox ® | — | — | — | 0.01 | — | — |
| 12 | | | | | | |
| Biosoft ® | — | — | — | — | 0.01 | — |
| N25-7 | | | | | | |
| Biosoft ® | — | — | — | — | — | 0.01 |
| ET-650 | | | | | | |
| Water | rem | rem | rem | rem | rem | rem |
| Log CFU | 3.2 | 3.5 | 2.3 | 3.7 | 4.0 | 4.0 |

“rem” indicates “remainder to 100 wt %”

### Example 11

### Spray Application Using Backpack Spray System

Coating composition #B154C of Example 1 was filled in a backpack spray system (SP Professional Backpack Sprayer, Model SP0, SP Systems LLC, Santa Monica, Calif., USA) equipped with a type AG03 spray nozzle. The backpack sprayer was pressurized to between 0.7 and 1.0 MPa using the integrated pump lever. A triangular fan with a fan opening angle of about 80 degrees was achieved. This allows the efficient and fast coverage of a spray zone of about 0.5 m width using a spray distance between spray nozzle and target surface of about 0.3 m. Excellent coverage and a homogenous coating without coating defects such as bubbles, cracks, craters, uncovered areas or dewetting effects was achieved.

### Example 12

### Spray Application of Coating Composition #248 Using Airless Spray Equipment

Coating composition #248 was applied to surfaces by spraying using an airless spray system (model President 46/1, Graco Inc., Minneapolis, Minn., USA). A liquid pressure of 31.7 MPa was used which resulted in excellent sprayability characteristics such efficient atomization, complete coverage and low tendency to sag or drip off vertical surfaces. The sag point is defined as the thickness of the coating after spraying on a vertical surface and drying at which the coatings starts to show visual sags or drips. The sag point was measured to be above 10 micrometers for coating composition #248 indicating a high resistance to sagging and dripping. The resulting coating after drying had an excellent appearance characterized by the absence of coating defects such as sags, foam or bubbles, craters or uncovered areas.

The application speed of the coating composition was measured to be about 8 to 15 m²/min depending on the speed of moving the spray gun across the surface to be sprayed. The consumption of the coating composition was between about 30 and 60 g/m², again depending on the speed of moving the spray gun across the target surface.

What is claimed is:

1. A method of providing control of microorganisms at a locus comprising the steps:
a) combining:
i) a water soluble or water-dispersible film-forming agent;
ii) at least one cationic or nonionic antimicrobial agent;
iii) an inert solvent;
iv) an acid activated rheology agent;
v) an acid in an amount effective to initiate thickening by the rheology agent of (iv) to obtain a removable coating composition; and
b) applying said coating composition to said locus.

2. The method of claim 1, wherein said coating composition further comprises: a first surfactant at a concentration from 0.001 to 5 wt % of said antimicrobial coating composition, and a second surfactant at a concentration of from 0.001 to 0.2 wt % of said antimicrobial coating composition; wherein said second surfactant is an alcohol ethoxylate.

3. The method of claim 1, wherein said antimicrobial agent comprises a quaternary ammonium compound.

4. The method of claim 1, wherein said rheology agent is an acrylic polymer comprising amine functional groups and hydrophobic functional groups.

5. The method of claim 1, wherein said acid is an alpha-hydroxy acid chosen from the group consisting of lactic acid or glycolic acid.

6. The method of claim 1, wherein the rheology agent and the acid are kept separated in a multi-compartment system prior to combining; wherein the rheology agent is part of a first liquid and the acid is part of a second liquid; wherein said coating composition is generated by mixing the first liquid and the second liquid prior to the application to the locus.

7. The method of claim 1, wherein said film-forming agent is polyvinylalcohol or copolymers thereof; wherein said antimicrobial agent comprises a quaternary ammonium compound; wherein said inert solvent is water and wherein said acid-activated rheology agent comprises an acrylic polymer comprising amine functional groups; and wherein the vapor pressure at 25° C. of said acid is below 1000 Pa.

8. The method of claim 1, wherein the viscosity of said coating composition measured at 10° C. and a shear rate of 1 s⁻¹, is between 0.5 and 100 Pa·s.

9. A removable antimicrobial coating composition for application at a locus, said composition obtained by combining:
i) a water soluble or water-dispersible film-forming agent;
ii) at least one cationic or nonionic antimicrobial agent;
iii) an inert solvent;
iv) an acid activated rheology agent; and
v) an acid in an amount effective to initiate thickening by the rheology agent of (iv).

10. The composition of claim 9, wherein said composition further comprises: a first surfactant at a concentration from 0.001 to 5 wt % of said antimicrobial coating composition, and a second surfactant at a concentration of from 0.001 to 0.2 wt % of said antimicrobial coating composition; wherein said second surfactant is an alcohol ethoxylate.

11. The composition of claim 9, wherein said antimicrobial agent comprises a quaternary ammonium compound.

12. The composition of claim 9, wherein said rheology agent is an acrylic polymer comprising amine functional groups and hydrophobic functional groups.

13. The composition of claim 9, wherein said acid is an alpha-hydroxy acid chosen from the group consisting of lactic acid or glycolic acid.

14. The composition of claim 9, wherein the rheology agent and the acid are kept separated in a multi-compartment system prior to combining; wherein the rheology agent is part of a first liquid and the acid is part of a second liquid; wherein said coating composition is generated by mixing the first liquid and the second liquid prior to the application to the locus.

15. The composition of claim 9, wherein said film-forming agent is polyvinylalcohol or copolymers thereof; wherein said antimicrobial agent comprises a quaternary ammonium compound; wherein said inert solvent is water and wherein said acid-activated rheology agent comprises an acrylic polymer comprising amine functional groups; and wherein the vapor pressure at 25° C. of said acid is below 1000 Pa.

16. The composition of claim 9, wherein the viscosity of said composition measured at 10° C. and a shear rate of 1 s⁻¹, is between 0.5 and 100 Pa·s.

17. An article comprising on at least one surface thereof a removable antimicrobial coating composition, wherein the composition comprises the reaction products obtained by combining:
i) a water soluble or water-dispersible film-forming agent;
ii) at least one antimicrobial agent;
iii) an inert solvent;
iv) an acid-activated rheology agent;
v) an acid in an amount effective to initiate thickening by the rheology agent of (iv).

18. The article of claim 17 wherein the at least one surface of the article comprises a material selected from the group consisting of: metals; minerals; natural and synthetic polymers; plastics; brick; tile; ceramic; porcelain; vinyl; glass; linoleum; and wood.

19. The article of claim 1 wherein the article is equipment used in the food or beverage industry.

20. The article of claim 1 wherein the article has a fibrous surface.
